(19) United States
(12) Patent Application Publication
(10) Pub. No.: US 2025/0156737 A1
(43) Pub. Date: May 15, 2025

(54) MINING AND VISUALIZING RELATED TOPICS IN A KNOWLEDGE BASE

(71) Applicant: Microsoft Technology Licensing, LLC, Redmond, WA (US)

(72) Inventors: Gaurish CHAUDHARI, Kirkland, WA (US); Guoku WANG, Sammamish, WA (US); Dmitriy MEYERZON, Bellevue, WA (US); Yuyang CHEN, Yarrow Point, WA (US); Karthik TANGIRALA, Bothell, WA (US); Omar Zia KHAN, Clyde Hill, WA (US); Eric GRADEL, Seattle, WA (US); Puneet NARULA, Bothell, WA (US); Zhihong SHEN, Redmond, WA (US); Chuang YU, Suzhou (CN); Vladimir V. GVOZDEV, Sammamish, WA (US); Ivan KOROSTELEV, London (GB); John M. WINN, Cambridge (GB); Wenbiao LAI, Snohomish, WA (US); Shilpa SHAH, Kirkland, WA (US)

(73) Assignee: Microsoft Technology Licensing, LLC, Redmond, WA (US)

(21) Appl. No.: 18/838,933

(22) PCT Filed: Feb. 28, 2022
(86) PCT No.: PCT/CN2022/078499

§ 371 Date: Aug. 15, 2024

(51) Int. Cl. G06N 5/025; G06F 16/9536; G06F 16/9538

(52) U.S. Cl. CPC G06N 5/025; G06F 16/9536; G06F 16/9538

(57) ABSTRACT

To mine and visualize related topics in a knowledge base, where a knowledge base is mined for related topics to create a knowledge graph that is output as a visualization display of automatically suggested related topics. To mine the knowledge base an approach has been developed which incorporates user personalized results in addition to semantic context. The results are displayed in a visualization display for user interaction. While interacting with a suggested topic the user can view and select related topic information which enables users to discover other similar or related topics they would be interested in gaining additional context about. Thus, the related topics and visualization display according to aspects described herein may serve the purpose of more effective utilization and exploration of the knowledge base.

### BACKGROUND

The use of network connected devices has become a necessity in modern life. Over time the utilization of network connected devices has generated an enormous volume of data. This data is often stored either locally or within in network connected databases which may constitute a knowledge base. Unfortunately, once the individual user or user group that created the data has finished with it, the data and more importantly any knowledge that could be useful to other users or user groups on the network, is often underutilized and perhaps forgotten.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to mining and visualizing related topics in a knowledge base, where a knowledge base is mined for related topics to create a knowledge graph that is output as a visualization display of automatically suggested related topics. To mine the knowledge base an approach has been developed which incorporates user personalized results in addition to semantic context. The results are displayed in a visualization display for user interaction. While interacting with a suggested topic the user can view and select related topic information which enables users to discover other similar or related topics, they would be interested in gaining additional context about. Thus, the related topics and visualization display according to aspects described herein may serve the purpose of more effective utilization and exploration of the knowledge base.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a diagram illustrating a system for mining the knowledge base and displaying the results to the user.

FIG. 2 is a block diagram illustrating a method for mining the knowledge base and displaying the results to the user.

FIG. 3 is a block diagram illustrating a method for generating a knowledge graph of unranked related topics.

FIG. 4 is a block diagram illustrating a method for ranking a knowledge graph with related topics ranked for importance.

FIG. 5 is a block diagram illustrating a method for filtering a knowledge graph.

FIG. 6 is a block diagram illustrating a method for ranking a knowledge graph for relevance.

FIG. 7 is a block diagram illustrating a method for updating the visualization display.

FIG. 8 is a block diagram illustrating a method for training the knowledge graph when ranking for relevance.

FIG. 9 is an example of the visualization display according to the aspects herein.

FIG. 10 is an example of the text box which appears when an edge between the root topic and a first level topic is selected.

FIG. 11 is an example of the text box which appears when a topic node is selected.

FIG. 12 is an example of the search function of the visualization display according to the aspects herein.

FIGS. 13A and 13B are examples of the topic data store and the displayed topic information according to the aspects described herein.

FIG. 14 is a block diagram illustrating example physical components of a computing device with which aspects of the disclosure may be practiced.

FIGS. 15A and 15B are simplified block diagrams of a mobile computing device with which aspects of the present disclosure may be practiced.

FIG. 16 is a simplified block diagram of a distributed computing system in which aspects of the present disclosure may be practiced.

FIG. 17 illustrates a tablet computing device or executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, an enterprise or other distributed network with many users generates and stores a very high volume of content within a knowledge base. Independently, the content in the knowledge base is useful on a limited basis within the narrow connections between users, documents, and other content already existing in a workflow, office, or project assignment management system. To improve content discoverability and provide additional context to the user it is preferable to define relationships between different content, group the related content into topics, define relationships between topics and present these related topics to the user. Most traditional approaches identify related content based on semantic context alone. However, the traditional approach is somewhat limited in that it does not personalize results based on the user. Rather, the traditional approach returns the same or similar results to each user using the same semantic context categorization criteria. As a result of being limited to connecting content based only on semantic context the defined relationships may lack richness or depth, which may also diminish the associated user experience.

Accordingly, aspects of the present disclosure relate to identifying related content, grouping related content into topics, and grouping topics into related topics based on a combination of semantic context and a user personalized knowledge graph. The approach aims to combine semantic context and a user personalized knowledge graph to connect related topics with a user in a generation pipeline across the network. Use of the knowledge graph enables the method to capture topic relatedness based on a plurality of topic nodes associated with network users. The approach provides the ability to retrieve high quality related topic candidates based on user association. The combination of semantic context and user association reduces incorrectly related topic candidates and improves ranking quality. The final output is displayed in a visualization display offering multiple options of possible related topics. In some examples the related topic options include curated, confirmed, and discovered related topics within a single visual display. This format simplifies related topic management over time and provides a compact view of interrelatedness while consuming and utilizing the information on the visualization display.

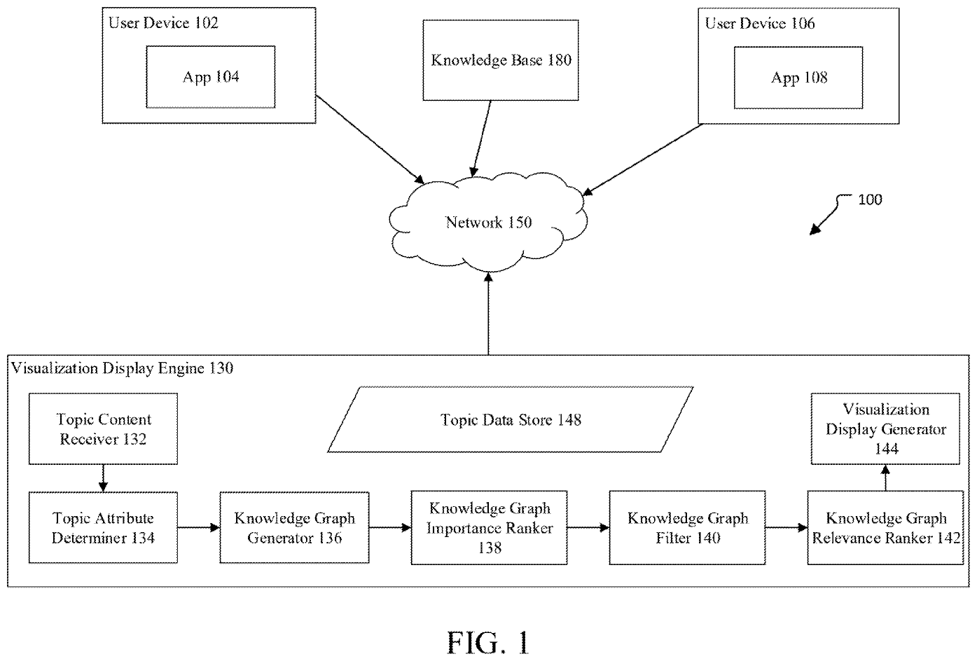

FIG. 1 illustrates an overview of an example system 100 for mining the knowledge base and displaying the results to the user according to aspects described herein. As illustrated, system 100 comprises a user device 102, app 104, user device 106, app 108, visualization display engine 130, network 150 and knowledge base 180. In examples, user devices 102 and 106, visualization display engine 130 and knowledge base 180 communicate via network 150, which may comprise a local area network, a wireless network, or the Internet, or any combination thereof, among other examples.

User device 102 may be any device that can receive, process, modify, and communicate content on the network 150. Examples of a user device include a desktop computer, laptop computer, tablet, and wireless device. In examples, the app 104 is an application on the user device 102 which displays content for use on the user device 102 and communication across the network 150. App 104 may be a native application or a web-based application. App 104 may operate substantially locally to computing device 104 or may operate according to a server/client paradigm in conjunction with one or more servers (not pictured). User device 106 and app 108 may be similar to user device 102 and app 104, and as such, aspects of user device 106 and app 108 are not necessarily re-described below in detail. The user device may generate content which will be stored in the knowledge base 180. The knowledge base 180 represents the accumulation of content across the distributed network, which may have been created, generated, sent, received and/or utilized on user devices 102 and 104. The knowledge base 180 is comprised of a plurality of entities including projects, processes, products, companies, events, departments, tools, platforms and/or organizations, etc. and their related content. Content may include information collected from across the distributed network including documents, emails, online chats, meetings mentioning a topic or user, presentations, an address or location where a meeting or event will take place, a video recording of a meeting that happened online, the information of all users who participated in a meeting, phone numbers, email addresses, user contact information, organization contact information, team contact information, metadata, individual users, teams of users, top contacts for a user and/or who a user communicates with regularly, etc. It should be appreciated that this list is not exhaustive, and that content comprises the full extent of information generated on the network.

Visualization display engine 130 may bring together the accumulated content from the knowledge base 180 and processes them into related topics that can be displayed across the distributed network as a visualization display. Visualization display engine 130 is illustrated as comprising topic content receiver 132, topic attribute determiner 134, knowledge graph generator 136, knowledge graph importance ranker 138, knowledge graph filter 140, knowledge graph relevance ranker 142, visualization display generator 144 and topic data store 148.

In examples, the topic content receiver 132 receives content from the knowledge base 180. Each piece of content is analyzed for relatedness to other content by the topic content receiver 132. Related content is categorized into topics. In examples, additional content associated with a topic after it has been categorized may become a separate topic itself. Thus, topic categorization can generate additional topics or additional content requests as additional relationships are recognized within the topic relative to the user. In this instance, the initial request for content and categorization of a topic may identify a user associated with the topic. Then, for the specific user, additional content may be analyzed from the knowledge base 180 to identify other related content, categorize new topics and/or determine the strength of the user's relationship to the original topic. For example, a topic may be categorized from a first piece of content received by the topic content receiver 132 about a meeting for project “Alpha.” Additional content associated with the meeting for project “Alpha” would also be received by the topic content receiver 132 which could include a list of invitees to the meeting, who has accepted the meeting, location of the meeting and/or contact information for meeting invitees. The combination of these pieces of content may be categorized into a topic. In some instances, the new topic would identify a user who is associated with the project like the project leader. Through additional analysis of other content streams (e.g., emails, meetings, chats, etc.) the strength of the user's relationship as project leader to the topic would be determined. The level of refinement in collecting content and categorizing topics may be adjusted based on the desired scope of the resulting visualization display output.

Content and/or topics may be stored in a topic data store 148. In aspects, the topic data store may store data for an individual user, may be a company-wide data store, encompass the entire distributed network and/or could be a tenant-wide data store. The topic data store 148 is a directory of topics and content about the topics, without defined relationships between topics. In examples, the topic data store may not be accessible to individual users on the network 150. In other examples, each topic within the topic data store may have its own topic page which is accessible to users on the network. If accessible, a user may have optional levels of interaction with the topic page. For example, a user might be able to search for and view a topic page or may have broad rights to search, view, and modify topic pages. Each topic page may provide additional content about the topic and any attributes which associated with the topic. In examples, as the visualization display engine 130 processes a topic the topic page may be updated with attributes, relationship information or other contextual signals on an ongoing basis.

In examples, the rate at which the topic content receiver 132 receives content and updates topics can be standardized or variable. In some examples, a standard update cycle may be in place where additional content is gathered and categorized as topics for the visualization display engine 130 to process. In such a case, there may be a period where the topic data store 148, topic pages and the results on the visualization display contain static results in between update cycles. In other examples, a continuous update cycle may exist where additional content is continuously received by the topic content receiver 132 to be processed by the visualization display engine 130. In such a case, the topic data store 148, topic pages and results on the visualization display may be continuously evolving into a more refined and robust presentation of information.

Once the topic content receiver 132 has received content and categorized it into topics the topic attribute determiner 134 may analyze the topic to generate a list of attributes associated with the topic. Topic attributes are underlying pieces of information that may describe the topic, be associated with the topic, be related to the topic and/or be specific to the type of topic. For example, the attribute may include the name of the topic, alternate names for the topic, a description of the topic, topic definitions, related people, related documents, related sites, related groups, related webpages as well as specific attributes for each type of topic such as project start/end date, project lead, project team members and/or project deadlines. Once determined, the information about the attributes of a topic may be maintained on the topic page in the topic data store 148. While visiting a topic page the related topic attributes enable discoveries about other similar or related topics to facilitate navigation and exploration of the knowledge base. In some instances, topic attributes function as a form of access control to restrict user access to a topic or content based on user permissions. In such an instance, when a topic page is accessed the topic attributes are checked against the user's permissions and only user accessible content will be available to the user. In some instances, for related topics, if the user doesn't have sufficient permission to view minimal information about a topic, the topic will not be visible to the user.

The knowledge graph generator 136 captures topic relatedness associated with a topic. The focus of the analysis is maximum candidate generation, which may be accomplished by utilizing a knowledge graph to retrieve all potential related topic candidates for each topic. The knowledge graph is a collection of related topics. Each topic on the knowledge graph includes its own content and attributes describing it. Additionally, the knowledge graph links the topic to other related topics for additional context. In some aspects, the list of related topic candidates may be generated based on key phrase extraction from the content, topic and/or topic attributes coupled with user information. Key phrase extraction may be performed by focusing on common content streams within the distributed network such as emails, documents, chats, a meeting mentioning the topic names they are associated with, together with other user information. In other aspects, the knowledge graph generator 136 may generate related topic candidates by analyzing relationship types with common edges across the topic data store 148. There are many possible relationship types that may be based on topics, users, and/or documents. In examples, one relationship type may be topic to topic where related topics are identified based on common project or department within a distributed network. A second relationship type could be topic to user where related topics shares common users, multiple users or user attributes. A third relationship type could be topic to document where a common topic generates certain related documents. A fourth relationship type may be user to user where user relationships are defined based on common organizations or shared qualifications within the distributed network. A fifth relationship type could be document to user based on users who have authored or edited a common document or similar documents. A sixth relationship type may be document to document where different relationships may be defined based on one document generating another document or series of documents or emails.

The knowledge graph generator 136 may identify common edges among relationship types by reverse mapping the relationship types for related topic, user and/or document connections and obtaining a list of related topic candidates linked to each user. The output structure of the knowledge graph generator 136 is a heterogeneous knowledge graph representing a list of related topics linked to each user. The knowledge graph consists of topics, users, and documents associated with related topics and users. In examples, each topic is arranged as a root topic node in a multi-level neighborhood subgraph. In this way, each related topic candidate is arrayed as a sub-level node connected to the root topic node. It should be appreciated that the number of levels extending out from the root topic node is variable and may consist of n-levels. The first level nodes after the root topic node may include immediate related users and documents closely connected to the root topic. The additional sub-level nodes may have a varying degree of relatedness to the root topic. Additional sub-level nodes may include other related topics, top ranked user contact lists from higher level nodes, and/or shared documents.

To determine initial positioning of topics within the n-levels of the knowledge graph, a personalized graph walk is performed on related topic candidates. The personalized graph walk identifies top related topic candidates with respect to the root topic. In examples, a two-level neighborhood subgraph connected to the root topic node may be generated. A personalized graph walk would be conducted on related topic candidates within the knowledge graph to identify first level topics and second level topics. In this example, the first and second level topic subgraphs include most topics that can be considered related to the root topic.

Once the knowledge graph generator 136 generates the n-level knowledge graph, the knowledge graph importance ranker 138 ranks each topic in each of the n-levels based on importance to the root topic. In examples, user-topic affinity features may be generated to assist with ranking the n-level topics for each user and root topic using a supervised machine learning ranking model. User-topic affinity features are enhanced analysis metrics that build upon the previously described common edges between topics. User-topic affinity features may analyze how often a topic occurs, where a topic is located within a document and/or who is involved with a topic on a recurring basis as a measurement function showing probability of past, present, and/or future occurrence. Examples of user-topic affinity features may include the number of times a topic appears in sent emails over the past few months, the number of occurrences of a word or phrase in the title of a document versus the body of a document, how often a topic occurs in meeting titles, how often a topic appears as a required invitee to a meeting versus an optional invitee and/or for each user a list of top contacts within the distributed network based on frequency of communication.

The knowledge graph importance ranker 138 may apply the user-topic affinity features to compute personalized page rank (PPR) scores of relative importance for the related topic candidates in the n-level subgraph to the root topic. The personalization vector may be set to always restart at the root topic node. At convergence, a PPR scores for all related n-level topic nodes in the subgraph may be obtained with respect to the root topic node. PPR scores may be aggregated for multiple relationship types such as topic to topic, topic to document, topic to user, user to user, user to document and/or document to document as described above. In instances, the knowledge graph importance ranker 138 may give additional weight to a certain relationship types to prioritize that relationship type. For example, user to topic and user to user relations may be more heavily weighted such that they have a higher rank. In instance, the knowledge graph importance ranker 138 may compute additional features within the importance ranking calculation to differentiate between related topic candidates within the n-level knowledge graph. For example, the knowledge graph importance ranker 138 may compute statistical topic metadata overlap features, semantic similarity between topic embeddings and/or semantic context analysis of topic candidates. The PPR scores may be used to rank and select n-level related topic candidates from among all potential related topic candidates within the root topic knowledge graph. The knowledge graph importance ranker 138 may generate PPR scores for all topics in the topic data store 148 and trivially parallelize the results across the distributed network.

The knowledge graph filter 140 further refines the importance ranked knowledge graph by filtering out related topic candidates based on filtering parameters. The filtering parameters could be any of multiple limits designed to remove noisy related topic candidates from the knowledge graph. Examples of filtering parameters include filtering out related topic candidates if they do not co-occur in any document from a topic within n-levels of the root topic, filtering out documents if they have not been accessed within a certain time period, filtering out users if there has been no communication within a certain time period and/or filtering out users based on location, etc.

Once the knowledge graph is ranked for importance and filtered, the knowledge graph relevance ranker 142 ranks the knowledge graph for relevance to the root topic. It should be appreciated that there are numerous methods to rank the related topic candidates within the knowledge graph for relevance to the root topic. One example may be to use the PPR scoring method described previously to rank remaining topic candidates post-filtering. In this instance, the related topic candidates would be ranked based on a PPR score for relevance and then the n-level knowledge graph would be adjusted accordingly. Another method may be to use a feature-based supervised machine learning ranking model trained with a few thousand labeled topic to topic pairs categorized by defined relevance features. In this method the relevance features are defined based on the desired output by the knowledge graph relevance ranker 142. Examples of possible topic to topic relevance features include a Jaccard overlap ratio between associated people and document sets for topic pairs, number of descriptions available for topic pairs, cosine similarity between topic embeddings produced on semantic content associated with topics, semantic embedding similarity on topic names, overlap ratio among established people for topics, semantic embedding similarity on topic names, count of established people for related topics, count of established documents for related topics, an overlap ratio among established documents for topics, count of definitions for related topics, semantic embedding similarity on top document titles, and/or count of definitions of source topic. The knowledge graph relevance ranker 142 may also leverage the pre-trained knowledge graph directly to produce topic embeddings and cosine similarity as described as part of the relevance features. In instances, these and/or other methods are used to run ranking model inference and obtain as output of the knowledge graph relevance ranker a knowledge graph with a ranked list of related topics across n-levels with a common root topic node.

The visualization display generator 144 presents a visual display of the ranked and filtered knowledge graph for user interaction. In instances, the visual display is presented in a graph visualization web component. The root topic may be shown as the central node of a n-level hub and spoke graph with related topics being shown at various levels on the n-level graph based on degree of relatedness. For example, the visual display may have two levels with first level topics shown closest to the root topic and connected to it by lines. Second level topic nodes, with lower degrees of relatedness to the root topic, could be shown further away from the root topic connected to the first level topics by lines. The nodes can be shown as a variety of shapes and the lines connecting the shapes may take different forms as well to indicate different information types to the user. For example, a node could be a circle, square and/or triangle while the line could be solid, dashed and/or dotted.

The visual display generator 144 may present a visual display which includes different types of nodes from the ranked and filtered n-level knowledge graph. One node type could be a discovered node which may represent a related topic discovered to the user awaiting either user confirmation or rejection of relatedness. A discovered node may be located at any n-level from the root topic node. A second node type could be a confirmed node which may represents a topic whose relatedness has been confirmed by a user. Confirmation of relatedness may occur upon selection of a discovered related topic or by manual curation of related topics by the user themselves. Manual curation may occur in multiple ways including searching the topic data store 148, adding a specific related topic directly and/or importing related topics from an external source. A confirmed topic may be located at any n-level from the root topic node and may be represented with a solid line between two solid circles. Rejected nodes are those which have been confirmed as not related to the root topic by the user. Rejected nodes may be removed from the visual display but the topic card remains in the topic data store 148. The visual display may also include an embedded topic legend where information about visual display is presented. The topic legend may include a variety information including line connection type, node type and/or a list of topics presented on the visual display as links to their topic page within the topic data store 148. In instances, the visual display generator 144 may present a two-level visual display comprised of discovered nodes and confirmed nodes connected on two levels to the root topic node. The visual display may also include a topic legend in the lower left corner.

The visual display generator 144 may enable user interaction with the visual display. In some instances, the visual display will enable users to access information cards about each root topic node and n-level nodes displayed. The topic information cards may be a summary of information from the topic page in the topic data store 148 or they may be the full topic data page. The information card may be accessed in a variety of ways including by hovering over a node, clicking the node and/or clicking and holding the node. Once accessed the information card may appear near the topic node on the visual display. Links on the information card may then be accessed in similar methods by clicking on, hovering over, or clicking and holding the link. Accessing information on the information card may allow users to traverse to other topics in the topic data store to either view that topic specifically and/or to generate another knowledge graph of related topics with the newly accessed topic as the root topic of the knowledge graph. In this way the expanse of information within the knowledge base 180 and topic data store 148 is accessible to a user as a series of topic pages and knowledge graphs with visual displays from the initial visual display.

Additionally, topics may be accessed by selecting a link from the listing on the topic legend of the visual display. In instances, an explanation of relatedness between topic nodes may be accessed by selecting the line connecting different nodes. The line may be selected in multiple ways including by clicking on, hovering over and/or clicking and holding the line. If the line is selected the visual display generator 148 presents an explanation in a text box of how and/or why two topic nodes are related to each other. For example, an explanation may include how many shared related people and/or related documents exist between the two nodes and/or the list of attributes common to both nodes. Topics may also be accessed directly by using a search function on the visual display. The search function may be selected in multiple ways including by clicking, hovering and/or clicking and hovering on the root topic node or some other area of the visual display. Once selected, the search function may appear as a blank search field into which text can be entered and searched for. As text is being entered search suggestions may be presented underneath the blank search field which may be selected if desired. Search results may appear on the same visual display or be presented on a new visual display. Search results may be links directly to topic pages within the topic data store 148 or to the knowledge graph visual display of the searched for topic as the root topic.

As will be appreciated, the various methods, devices, apps, nodes, features, etc., described with respect to FIG. 1 or any of the figures described herein, are not intended to limit the system to being performed by the particular apps and features described. Accordingly, additional configurations may be used to practice the methods and systems herein and/or features and apps described may be excluded without departing from the methods and systems disclosed herein.

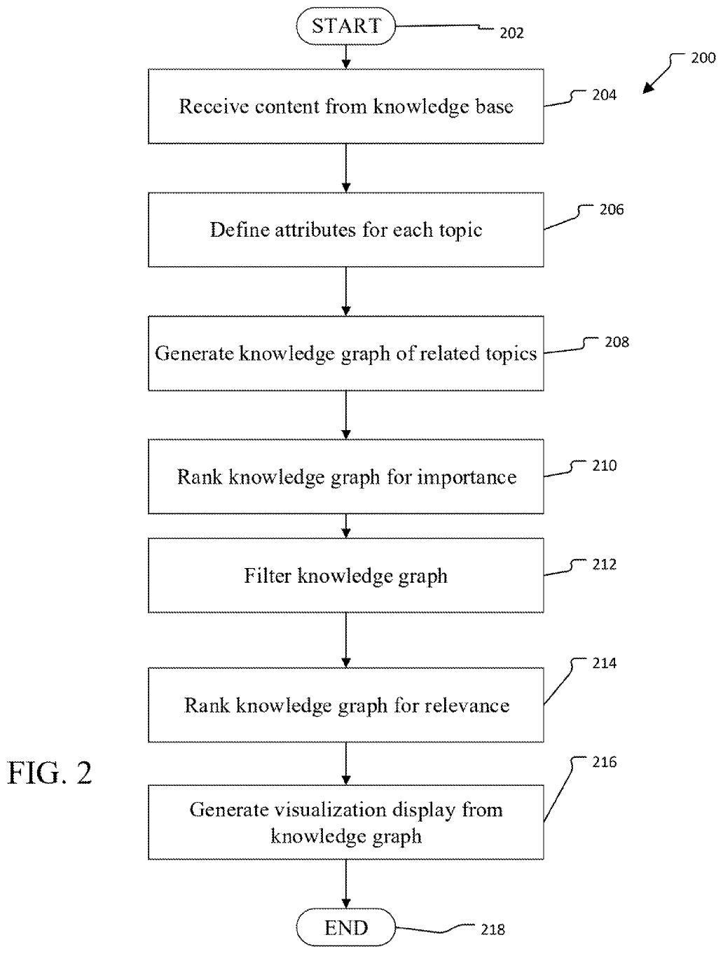

FIG. 2 is an example of a method for mining the knowledge base and displaying the results to the user. A general order of the operations for the method 200 is shown in FIG. 2. Generally, the method 200 begins with start operation 202 and ends with end operation 218. The method 200 may include more or fewer steps or may arrange the order of the steps differently than those shown in FIG. 2. The method 200 can be executed as computer-executable instructions executed by a computer system and encoded or stored on a computer readable medium. Further, the method 200 can be performed by gates or circuits associated with a processor, an ASIC, an FPGA, a SOC or other hardware device. Hereinafter, the method 200 shall be explained with reference to the systems, components, devices, modules, software, data structures, data characteristic representations, signaling diagrams, methods, etc., described in conjunction with FIGS. 1, 3, 4, 5, 6, 7, 8, 9, 10, 11, 12, 13A, 13B, 14, 15A, 15B, 16, and 17.

Following the start operation 202, the method 200 begins with the receive operation 204, which receives content from the knowledge base and categorizes related content as topics. The received content may include information collected from across the distributed network including documents, emails, online chats, meetings mentioning a topic or user, presentations, an address or location where a meeting or event will take place, a video recording of a meeting that happened online, the information of all users who participated in a meeting, phone numbers, email addresses, user contact information, organization contact information, team contact information, metadata, individual users, teams of users, top contacts for a user and/or who a user communicates with regularly, etc.

The define operation 206, defines attributes for each topic. Topic attributes are underlying pieces of information that may describe the topic, be associated with the topic or be related to the topic. For example, the attribute may include the name of the topic, alternate names for the topic, a description of the topic, topic definitions, related people, related documents and/or related webpages as well as specific attributes for each type of topic such as project start/end date, project lead or team members and/or project deadlines.

Generate operation 208, generates a knowledge graph of related topics by linking the topics with related attributes. An n-level knowledge graph is generated with each topic as a root level node of its own knowledge graph.

Rank operation 210, ranks the related topics in the knowledge graph for importance relative to the root topic using PPR scores. PPR scores may be generated based on multiple relationship types including topic to topic, topic to document, topic to user, user to user, user to document, and document to document relative to the root topic.

Filter operation 212, filters the related topics in the knowledge graph. Related topics may be filtered out based on filtering parameters such as filtering out related topic candidates if they do not co-occur in any document from a topic within n-levels of the root topic, filtering out documents if they have not been accessed within a certain time period, filtering out users if there has been no communication within a certain time period and/or filtering out users based on location, etc.

Rank operation 214, ranks the knowledge graph for relevance based on affinity to the root topic. It should be appreciated that there are numerous methods to rank the related topic candidates within the knowledge graph for relevance to the root topic. One example may be to use the PPR scoring method described previously to rank remaining topic candidates post-filtering. Another method may be to use a feature-based supervised machine learning ranking model trained with a few thousand labeled topic to topic pairs categorized by defined relevance features.

Generate operation 216, generates the visualization display from the ranked and filtered related topics in the knowledge graph. The visualization display may be presented as a graph visualization web component. The root topic may be shown as the central node of a n-level hub and spoke graph with related topics being shown at various levels on the n-level graph based on degree of relatedness. In aspects it may be possible that the visualization display may contain discovered related topics and confirmed related topics as n-level nodes on the presentation. In aspects it may be possible to interact with the visualization display to curate topic nodes, gather information and/or search for other related topics. The method operation ends with the end operation 218.

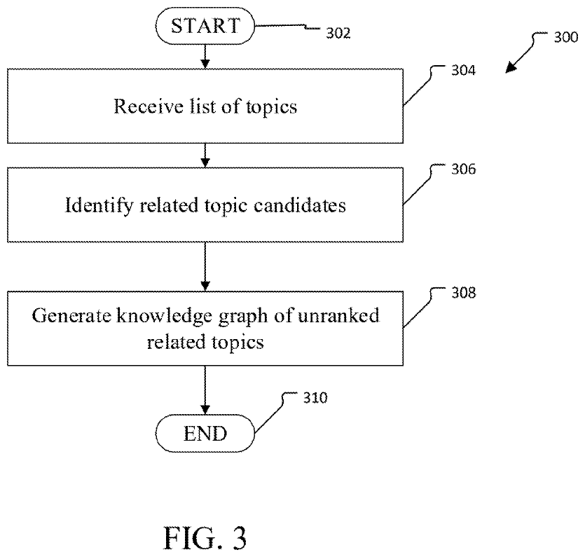

FIG. 3 is a block diagram illustrating a method for generating a knowledge graph of unranked related topics. A general order of the operations for the method 300 is shown in FIG. 3. Generally, the method 300 begins with start operation 302 and ends with end operation 310. The method 300 may include more or fewer steps or may arrange the order of the steps differently than those shown in FIG. 3. The method 300 can be executed as computer-executable instructions executed by a computer system and encoded or stored on a computer readable medium. Further, the method 300 can be performed by gates or circuits associated with a processor, an ASIC, an FPGA, a SOC or other hardware device. Hereinafter, the method 300 shall be explained with reference to the systems, components, devices, modules, software, data structures, data characteristic representations, signaling diagrams, methods, etc., described in conjunction with FIGS. 1, 2, 4, 5, 6, 7, 8, 9, 10, 11, 12, 13A, 13B, 14, 15A, 15B, 16, and 17.

Following the start operation 302, the method 300 begins with the receive operation 304 which receives a list of topics. The list of topics is created based on content in the knowledge base and may be further defined by attribute.

Identify operation 306, identifies related topic candidates for each topic from the received topic list. Related topic candidates may be identified by focusing on common content streams within the distributed network such as emails, documents, chats, meeting mentioning the topic names they are associated with and the like. In other aspects, related topic candidates may be identified by analyzing relationship types with common edges across the topic data store 148.

Generate operation 308, generates a knowledge graph of unranked related topics. A knowledge graph may be generated for each topic as a root topic connected to related topics across n-levels. The method operation ends with the end operation 310.

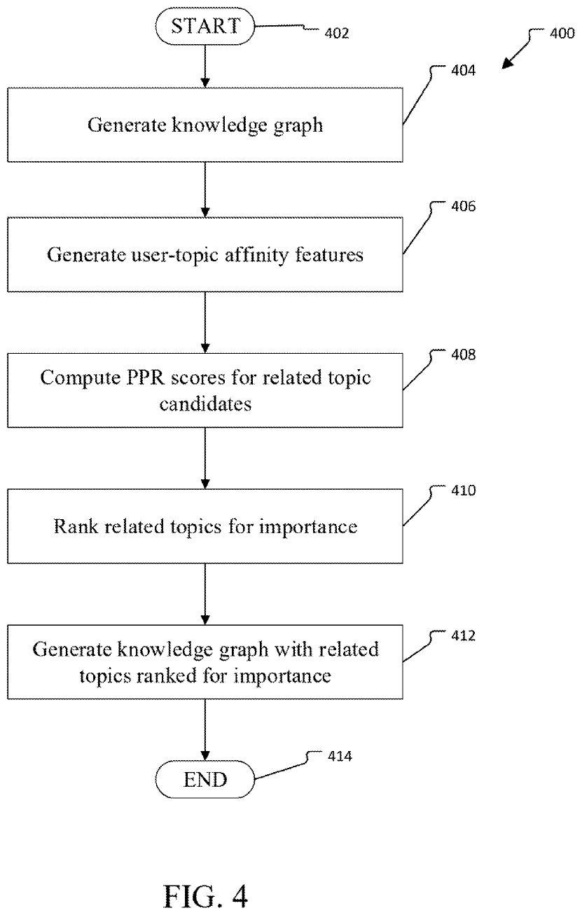

FIG. 4 is a block diagram illustrating a method for ranking a knowledge graph with related topics ranked for importance. A general order of the operations for the method 400 is shown in FIG. 4. Generally, the method 400 begins with start operation 402 and ends with end operation 414. The method 400 may include more or fewer steps or may arrange the order of the steps differently than those shown in FIG. 4. The method 400 can be executed as computer-executable instructions executed by a computer system and encoded or stored on a computer readable medium. Further, the method 400 can be performed by gates or circuits associated with a processor, an ASIC, an FPGA, a SOC or other hardware device. Hereinafter, the method 400 shall be explained with reference to the systems, components, devices, modules, software, data structures, data characteristic representations, signaling diagrams, methods, etc., described in conjunction with FIGS. 1, 2, 3, 5, 6, 7, 8, 9, 10, 11, 12, 13A, 13B, 14, 15A, 15B, 16, and 17.

Following the start operation 402, the method 400 begins with the generate operation 404 which generates a knowledge graph as described herein.

Generate operation 406, generates user-topic affinity features for the related topics in the knowledge graph. User-topic affinity features are enhanced analysis metrics which build upon the previously described common edges between topics. User-topic affinity features may analyze how often a topic occurs, where a topic is located within a document and/or who is involved with a topic on a recurring basis as a measurement function showing probability of past, present, and/or future occurrence.

Compute operation 408, computes PPR scores for related topic candidates. The personalization vector may be set to always restart at the root topic node. PPR scores may be aggregated for multiple relationship types such as topic to topic, topic to document, topic to user, user to user, user to document and/or document to document as described above. In instances, additional weight may be given to certain relationship types to prioritize that relationship types PPR score.

Rank operation 410, ranks related topic candidates within the n-level knowledge graph based on PPR score. The related topics with higher PPR scores may be moved into a higher level of the n-level knowledge graph, closer to the root topic.

Generate operation 412, generates a knowledge graph with related topics ranked for importance. The n-levels of the knowledge graph may be adjusted to shift related topics up or down based on their PPR score. The method operation ends with end operation 414.

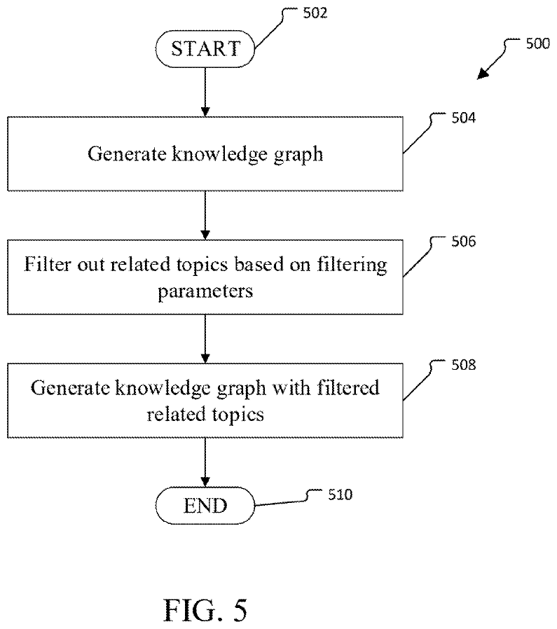

FIG. 5 is a block diagram illustrating a method for filtering a knowledge graph. A general order of the operations for the method 500 is shown in FIG. 5. Generally, the method 500 begins with start operation 502 and ends with end operation 510. The method 500 may include more or fewer steps or may arrange the order of the steps differently than those shown in FIG. 5. The method 500 can be executed as computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2, 3, 4, 6, 7, 8, 9, 10, 11, 12, 13A, 13B, 14, 15A, 15B, 16, and 17.

Following the start operation 502, the method 500 begins with the generate operation 504 which generates a knowledge graph of related topics as described herein.

Filter operation 506, filters out related topics based on filtering parameters. Related topics may be filtered out based on filtering parameters such as filtering out related topic candidates if they do not co-occur in any document from a topic within n-levels of the root topic, filtering out documents if they have not been accessed within a certain time period, filtering out users if there has been no communication within a certain time period and/or filtering out users based on location, etc.

Generate operation 508, generates a knowledge graph with filtered related topics. The n-levels of the knowledge graph may be adjusted to remove related topics who do or do not satisfy the filtering parameters. The method operation ends with end operation 510.

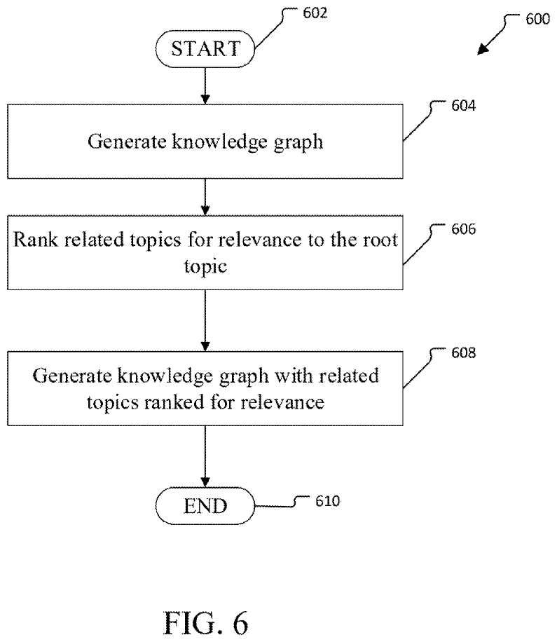

FIG. 6 is a block diagram illustrating a method for ranking a knowledge graph for relevance. A general order of the operations for the method 600 is shown in FIG. 6. Generally, the method 600 begins with start operation 602 and ends with end operation 614. The method 600 may include more or fewer steps or may arrange the order of the steps differently than those shown in FIG. 6. The method 600 can be executed as computer-executable instructions executed by a computer system and encoded or stored on a computer readable medium. Further, the method 600 can be performed by gates or circuits associated with a processor, an ASIC, an FPGA, a SOC or other hardware device. Hereinafter, the method 600 shall be explained with reference to the systems, components, devices, modules, software, data structures, data characteristic representations, signaling diagrams, methods, etc., described in conjunction with FIGS. 1, 2, 3, 4, 5, 7, 8, 9, 10, 11, 12, 13A, 13B, 14, 15A, 15B, 16, and 17.

Following the start operation 602, the method 600 begins with the generate operation 604 which generates a knowledge graph of related topics as described herein.

Rank operation 604, ranks related topics in the knowledge graph for relevance to the root topic. There are many possible ways to determine relevance to the root topic. In one instance, a PPR score for relevance could be generated as described above. In another instance, a feature-based supervised machine learning ranking model trained with a few thousand labeled topic to topic pairs categorized by defined relevance features could be utilized to rank related topics. The relevance features may also include the pre-trained knowledge graph directly to produce topic embeddings and cosine similarity in the ranking model.

Generate operation 608, generates a knowledge graph with filtered related topics. The n-levels of the knowledge graph may be adjusted to remove related topics who do or do not satisfy the filtering parameters. The method operation ends with end operation 610.

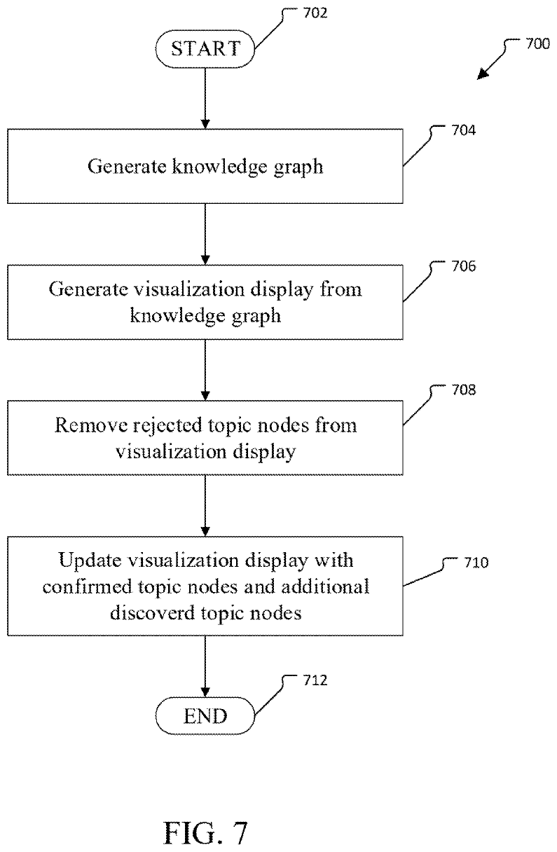

FIG. 7 is a block diagram illustrating a method for updating the visualization display. A general order of the operations for the method 700 is shown in FIG. 7. Generally, the method 700 begins with start operation 702 and ends with end operation 712. The method 700 may include more or fewer steps or may arrange the order of the steps differently than those shown in FIG. 7. The method 700 can be executed as computer-executable instructions executed by a computer system and encoded or stored on a computer readable medium. Further, the method 700 can be performed by gates or circuits associated with a processor, an ASIC, an FPGA, a SOC or other hardware device. Hereinafter, the method 700 shall be explained with reference to the systems, components, devices, modules, software, data structures, data characteristic representations, signaling diagrams, methods, etc., described in conjunction with FIGS. 1, 2, 3, 4, 5, 6, 8, 9, 10, 11, 12, 13A, 13B, 14, 15A, 15B, 16, and 17.

Following the start operation 702, the method 700 begins with the generate operation 704 which generates a knowledge graph of related topics as described herein.

Generate operation 706, generates a visualization display from the knowledge graph. The visual display may be generated as a graph visualization web component. A root topic may be shown as the central node of a n-level graph with related topics being shown at various levels on the n-level graph based on degree of relatedness. The visualization display may include a topic legend on the page which may provide information about the graph itself and/or information about the related topics presented on the visualization display. The visualization display may include discovered topic nodes, which may be confirmed or rejected; and confirmed topic nodes which have been confirmed as related to the topic nodes.

Remove operation 708, removes discovered topic nodes that have been rejected as not related to the root topic. The visualization display may offer discovered topic nodes which can be confirmed as related to the root topic or rejected as not related to the root topic. If a discovered topic node is rejected, then it will be removed from the visualization display.

Update operation 710, updates the visualization display with confirmed topic nodes and additional discovered topic nodes. Following the remove operation, the visualization display may be updated with the confirmed related topic nodes as well as additional discovered topic nodes. The additional discovered topic nodes may be generated based on a selection of a confirmed related topic or based on a rejection of a topic. The method operation ends with end operation 712.

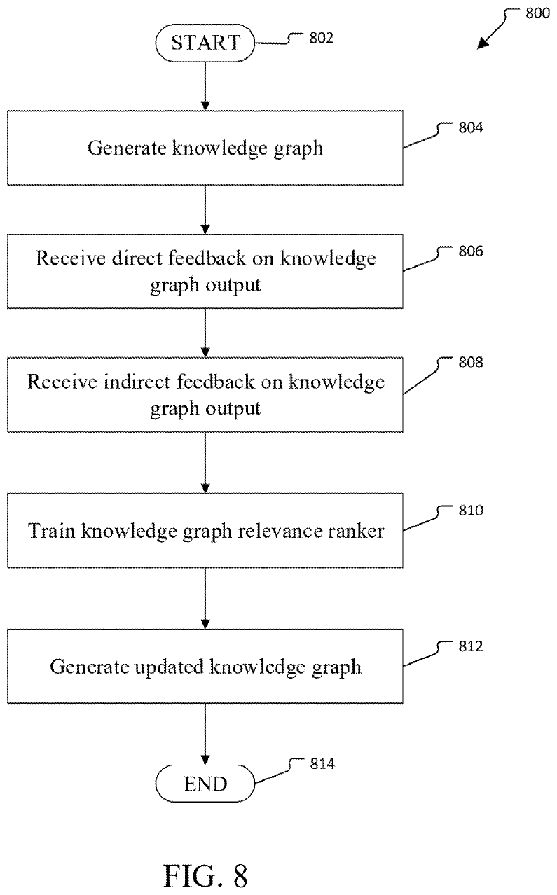

FIG. 8 is a block diagram illustrating a method for training the knowledge graph when ranking for relevance. A general order of the operations for the method 800 is shown in FIG. 8. Generally, the method 800 begins with start operation 802 and ends with end operation 814. The method 800 may include more or fewer steps or may arrange the order of the steps differently than those shown in FIG. 8. The method 800 can be executed as computer-executable instructions executed by a computer system and encoded or stored on a computer readable medium. Further, the method 800 can be performed by gates or circuits associated with a processor, an ASIC, an FPGA, a SOC or other hardware device. Hereinafter, the method 800 shall be explained with reference to the systems, components, devices, modules, software, data structures, data characteristic representations, signaling diagrams, methods, etc., described in conjunction with FIGS. 1, 2, 3, 4, 5, 6, 7, 9, 10, 11, 12, 13A, 13B, 14, 15A, 15B, 16, and 17.

Following the start operation 802, the method 800 begins with the generate operation 804 which generates a knowledge graph of related topics as described herein.

Receive operation 806, receives direct feedback on the knowledge graph output in the visualization display. Direct feedback may be generated by direct interaction with visualization display users. in multiple ways including by logging confirmation and/or rejection of discovered topics, monitoring search history for searched but not confirmed topics and/or searched and confirmed topics, etc. In instances, search queries that match exactly with topic names may be treated as related topics.

Receive operation 808, receives indirect feedback on the knowledge graph output in the visualization display. Indirect feedback is relied upon in the absence of direct feedback. Indirect feedback may be generated in multiple ways including confirmation and/or rejection of discovered topics on the visualization display, multiple confirmed topic nodes across multiple levels of the n-level visualization display, monitoring search history for searched but not confirmed topics and/or searched and confirmed topics and/or related topics leading to the same clicked documents in the visualization display and/or in a search history log.

Train operation 810, trains the knowledge graph relevance ranker with the direct and indirect feedback. In the absence of direct feedback, indirect feedback may be utilized to train the knowledge graph relevance ranker with novel weakly-supervised labeled sets using machine learning.

Generate operation 812, generates an updated knowledge graph based on the training model. The n-levels of the knowledge graph may be adjusted based on the training model. The training model may use only statistical features and once trained is applicable over a range of users. The method operation ends with end operation 814.

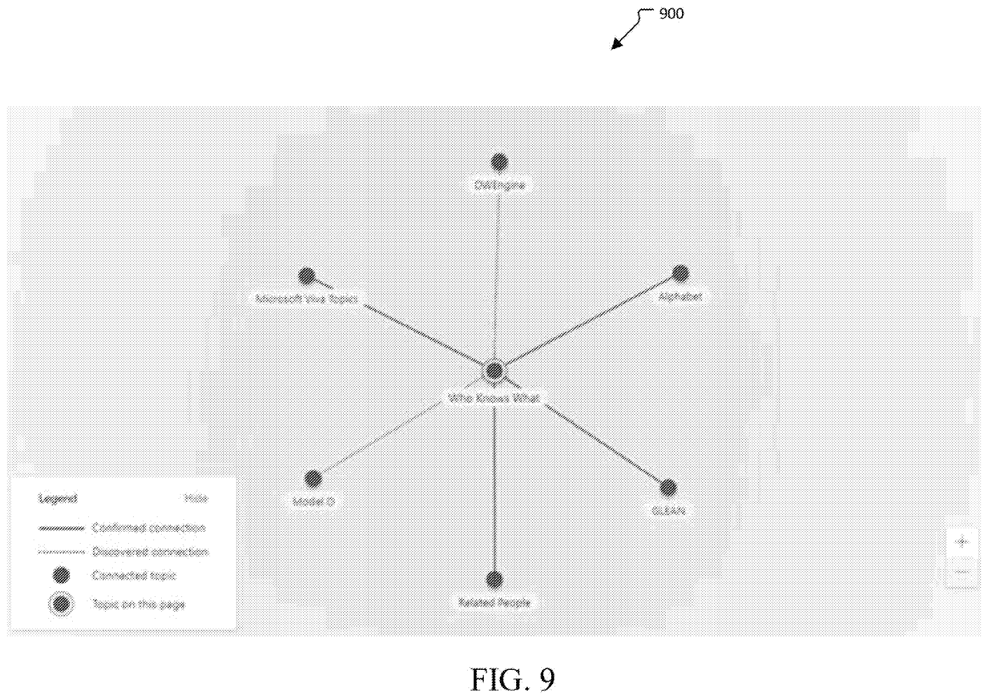

FIG. 9 is an example of the visualization display according to the aspects herein. In this instance the visualization display is shown with only first level topic nodes. The name of the topic node is displayed near the node itself. The root topic node is shown in the as a solid circle with another circle around it. Confirmed topic nodes are displayed as solid circles connected by a sold line to the root topic node. Discovered topic nodes are shown as solid circles connected with dotted lines to the root topic. The topic legend is displayed in the lower left corner of the visualization display.

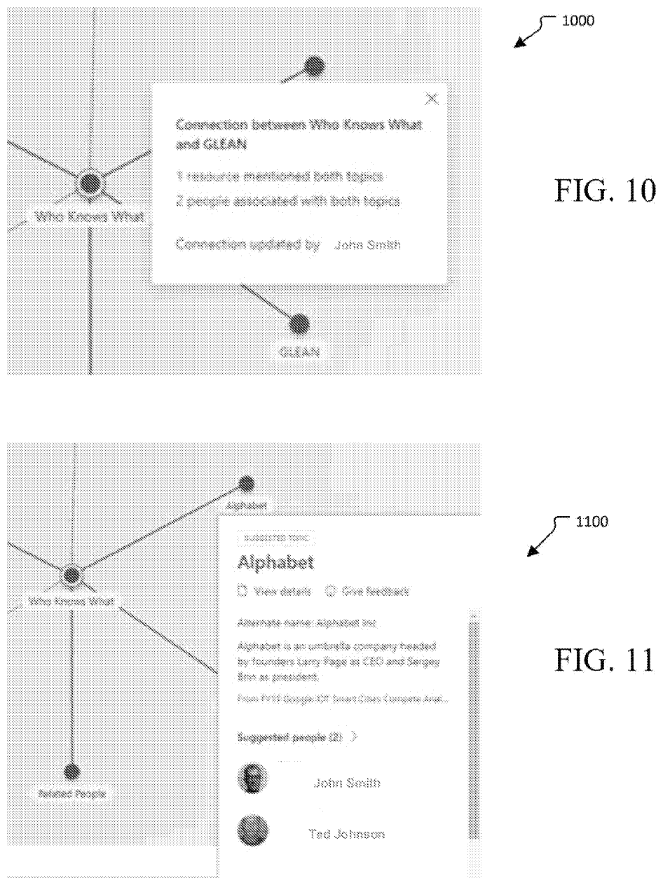

FIG. 10 is an example of the text box which appears when a connection line between the root topic and a first level topic is selected. In this instance, the text box appears near the selected connection line. The text box contains certain pieces of information about why the two topics are related as well as links to additional information.

FIG. 11 is an example of the text box which appears when a topic node is selected. In this instance, the text box appears near the selected node. The text box contains certain pieces of information about the topic as well as links to additional information.

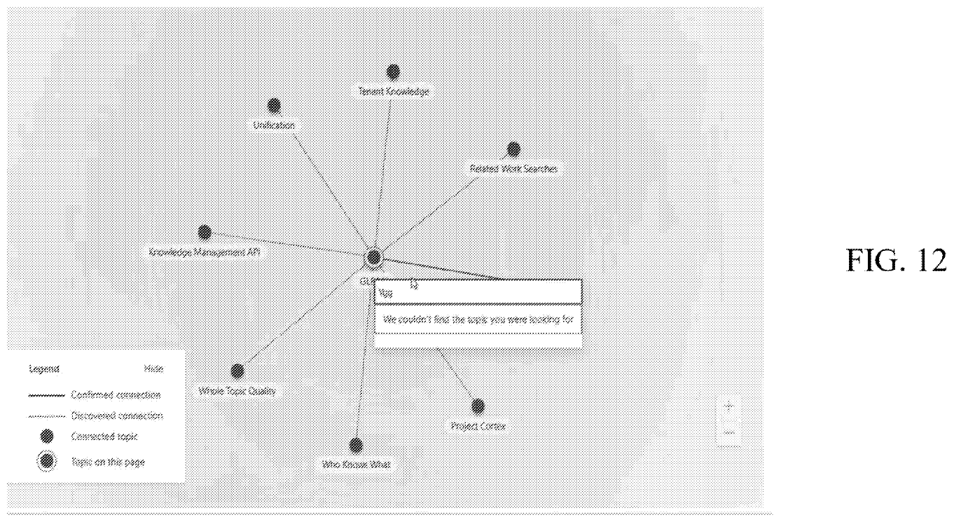

FIG. 12 is an example of the search function of the visualization display according to the aspects herein. In this instance, the text box is displayed near the root topic node. It is a blank field allowing for text entry with displayed results showing beneath the blank field.

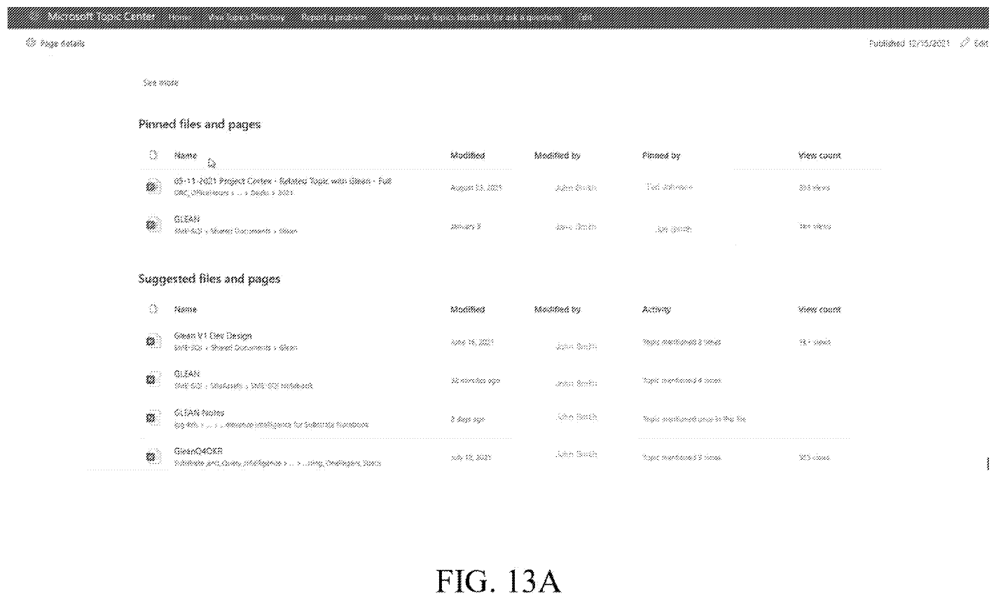

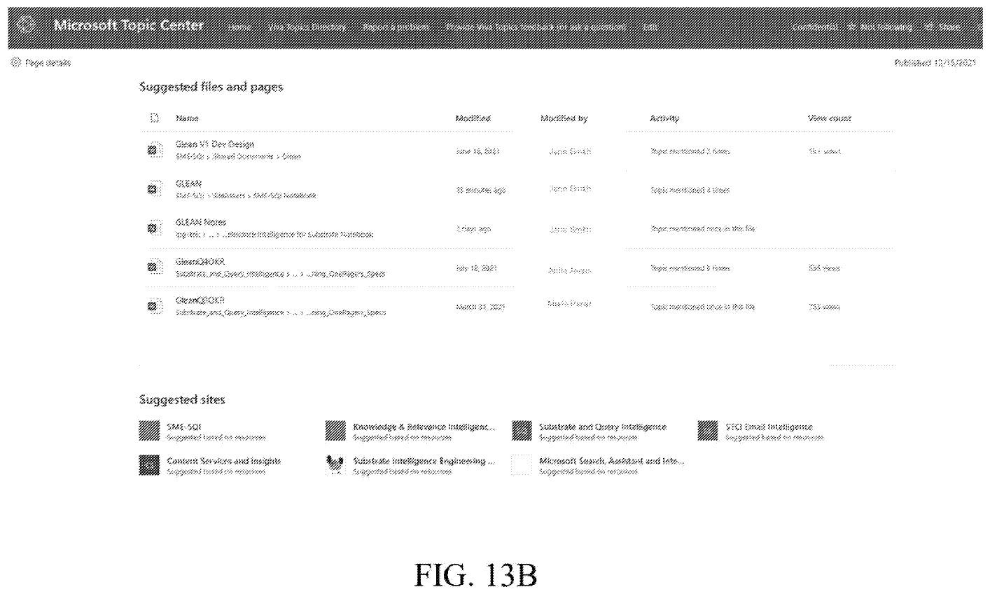

FIGS. 13A and 13B are examples of the topic data store and the displayed topic content according to the aspects described herein. In this instance they include both confirmed and suggested files and pages containing a variety of topic content, documents, files and suggested sites.

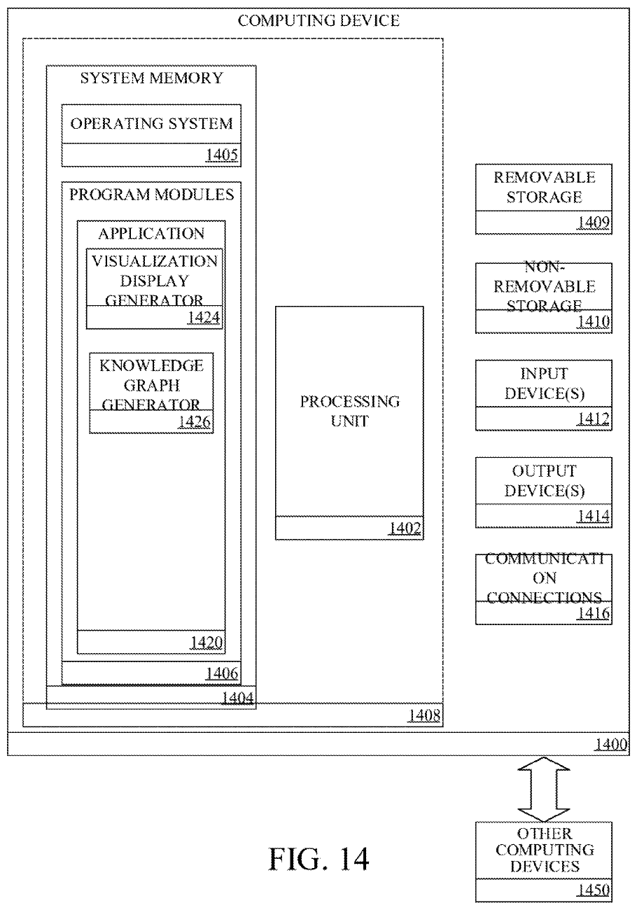

FIG. 14 is a block diagram illustrating example physical components of a computing device with which aspects of the disclosure may be practiced. is a block diagram illustrating physical components (e.g., hardware) of a computing device 1400 with which aspects of the disclosure may be practiced. The computing device components described below may be suitable for the computing devices described above, including devices 104 and/or 106, as well as one or more devices discussed above with respect to FIG. 1. In a basic configuration, the computing device 1400 may include at least one processing unit 1402 and a system memory 1404. Depending on the configuration and type of computing device, the system memory 1404 may comprise, but is not limited to, volatile storage (e.g., random access memory), non-volatile storage (e.g., read-only memory), flash memory, or any combination of such memories.

The system memory 504 may include an operating system 1405 and one or more program modules 1406 suitable for running software application 1420, such as one or more components supported by the systems described herein. As examples, system memory 1404 may store the visualization display generator 1424 and knowledge graph generator 1426. The operating system 1405, for example, may be suitable for controlling the operation of the computing device 1400.

Furthermore, embodiments of the disclosure may be practiced in conjunction with a graphics library, other operating systems, or any other application program and is not limited to any particular application or system. This basic configuration is illustrated in FIG. 14 by those components within a dashed line 1408. The computing device 1400 may have additional features or functionality. For example, the computing device 1400 may also include additional data storage devices (removable and/or non-removable) such as, for example, magnetic disks, optical disks, or tape. Such additional storage is illustrated in FIG. 14 by a removable storage device 1409 and a non-removable storage device 1410.

As stated above, a number of program modules and data files may be stored in the system memory 1404. While executing on the processing unit 1402, the program modules 1406 (e.g., application 1420) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 14 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1400 may also have one or more input device(s) 1412 such as a keyboard, a mouse, a pen, a sound or voice input device, a touch or swipe input device, etc. The output device(s) 1414 such as a display, speakers, a printer, etc. may also be included. The aforementioned devices are examples and others may be used. The computing device 1400 may include one or more communication connections 1416 allowing communications with other computing devices 1450. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1404, the removable storage device 1409, and the non-removable storage device 1410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1400. Any such computer storage media may be part of the computing device 1400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

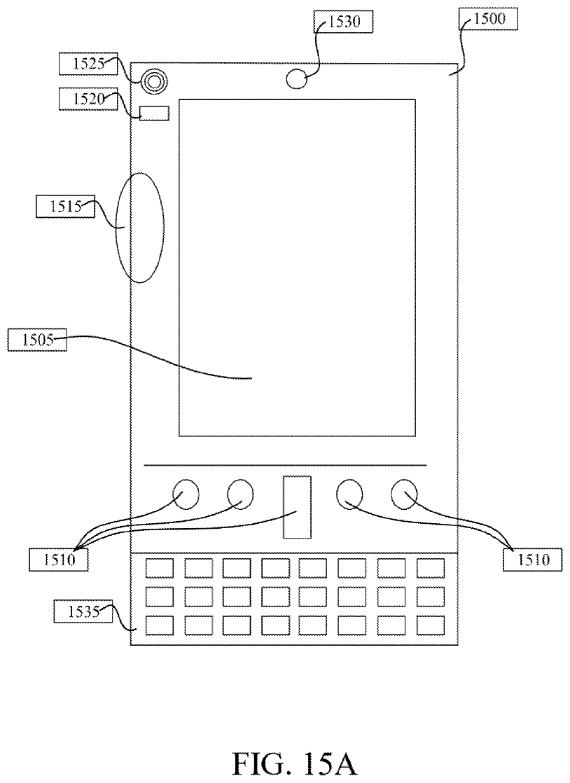

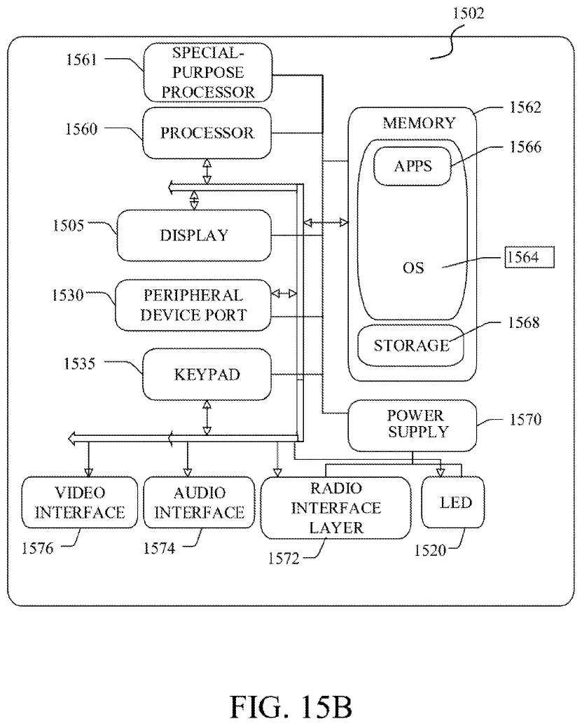

FIGS. 15A and 15B illustrate a mobile computing device 1500, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 15A, one aspect of a mobile computing device 1500 for implementing the aspects is illustrated. In a basic configuration, the mobile computing device 1500 is a handheld computer having both input elements and output elements. The mobile computing device 1500 typically includes a display 1505 and one or more input buttons 1510 that allow the user to enter information into the mobile computing device 1500. The display 1505 of the mobile computing device 1500 may also function as an input device (e.g., a touch screen display).

If included, an optional side input element 1515 allows further user input. The side input element 1515 may be a rotary switch, a button, or any other type of manual input element. In alternative aspects, mobile computing device 1500 may incorporate more or less input elements. For example, the display 1505 may not be a touch screen in some embodiments.

In yet another alternative embodiment, the mobile computing device 1500 is a portable phone system, such as a cellular phone. The mobile computing device 1500 may also include an optional keypad 1535. Optional keypad 1535 may be a physical keypad or a “soft” keypad generated on the touch screen display.

In various embodiments, the output elements include the display 1505 for showing a graphical user interface (GUI), a visual indicator 1520 (e.g., a light emitting diode), and/or an audio transducer 1525 (e.g., a speaker). In some aspects, the mobile computing device 1500 incorporates a vibration transducer for providing the user with tactile feedback. In yet another aspect, the mobile computing device 1500 incorporates input and/or output ports, such as an audio input (e.g., a microphone jack), an audio output (e.g., a headphone jack), and a video output (e.g., a HDMI port) for sending signals to or receiving signals from an external device.

FIG. 15B is a block diagram illustrating the architecture of one aspect of a mobile computing device. That is, the mobile computing device 1500 can incorporate a system (e.g., an architecture) 1502 to implement some aspects. In one embodiment, the system 1502 is implemented as a “smart phone” capable of running one or more applications (e.g., browser, e-mail, calendaring, contact managers, messaging clients, games, and media clients/players). In some aspects, the system 1502 is integrated as a computing device, such as an integrated personal digital assistant (PDA) and wireless phone.

One or more application programs 1566 may be loaded into the memory 1562 and run on or in association with the operating system 1564. Examples of the application programs include phone dialer programs, e-mail programs, personal information management (PIM) programs, word processing programs, spreadsheet programs, Internet browser programs, messaging programs, and so forth. The system 1502 also includes a non-volatile storage area 1568 within the memory 1562. The non-volatile storage area 1568 may be used to store persistent information that should not be lost if the system 1502 is powered down. The application programs 1566 may use and store information in the non-volatile storage area 1568, such as e-mail or other messages used by an e-mail application, and the like. A synchronization application (not shown) also resides on the system 1502 and is programmed to interact with a corresponding synchronization application resident on a host computer to keep the information stored in the non-volatile storage area 1568 synchronized with corresponding information stored at the host computer. As should be appreciated, other applications may be loaded into the memory 1562 and run on the mobile computing device 1500 described herein.

The system 1502 has a power supply 1570, which may be implemented as one or more batteries. The power supply 1570 might further include an external power source, such as an AC adapter or a powered docking cradle that supplements or recharges the batteries.

The system 1502 may also include a radio interface layer 1572 that performs the function of transmitting and receiving radio frequency communications. The radio interface layer 1572 facilitates wireless connectivity between the system 1502 and the “outside world,” via a communications carrier or service provider. Transmissions to and from the radio interface layer 1572 are conducted under control of the operating system 1564. In other words, communications received by the radio interface layer 1572 may be disseminated to the application programs 1566 via the operating system 1564, and vice versa.

The visual indicator 1520 may be used to provide visual notifications, and/or an audio interface 1574 may be used for producing audible notifications via the audio transducer 1525. In the illustrated embodiment, the visual indicator 1520 is a light emitting diode (LED) and the audio transducer 1525 is a speaker. These devices may be directly coupled to the power supply 1570 so that when activated, they remain on for a duration dictated by the notification mechanism even though the processor 1560 and other components might shut down for conserving battery power. The LED may be programmed to remain on indefinitely until the user takes action to indicate the powered-on status of the device. The audio interface 1574 is used to provide audible signals to and receive audible signals from the user. For example, in addition to being coupled to the audio transducer 1525, the audio interface 1574 may also be coupled to a microphone to receive audible input, such as to facilitate a telephone conversation. In accordance with embodiments of the present disclosure, the microphone may also serve as an audio sensor to facilitate control of notifications, as will be described below. The system 1502 may further include a video interface 1576 that enables an operation of an on-board camera 1530 to record still images, video stream, and the like.

A mobile computing device 1500 implementing the system 1502 may have additional features or functionality. For example, the mobile computing device 1500 may also include additional data storage devices (removable and/or non-removable) such as, magnetic disks, optical disks, or tape. Such additional storage is illustrated in FIG. 15B by the non-volatile storage area 1568.

Data/information generated or captured by the mobile computing device 1500 and stored via the system 1502 may be stored locally on the mobile computing device 1500, as described above, or the data may be stored on any number of storage media that may be accessed by the device via the radio interface layer 1572 or via a wired connection between the mobile computing device 1500 and a separate computing device associated with the mobile computing device 1500, for example, a server computer in a distributed computing network, such as the Internet. As should be appreciated such data/information may be accessed via the mobile computing device 1500 via the radio interface layer 1572 or via a distributed computing network. Similarly, such data/information may be readily transferred between computing devices for storage and use according to well-known data/information transfer and storage means, including electronic mail and collaborative data/information sharing systems.

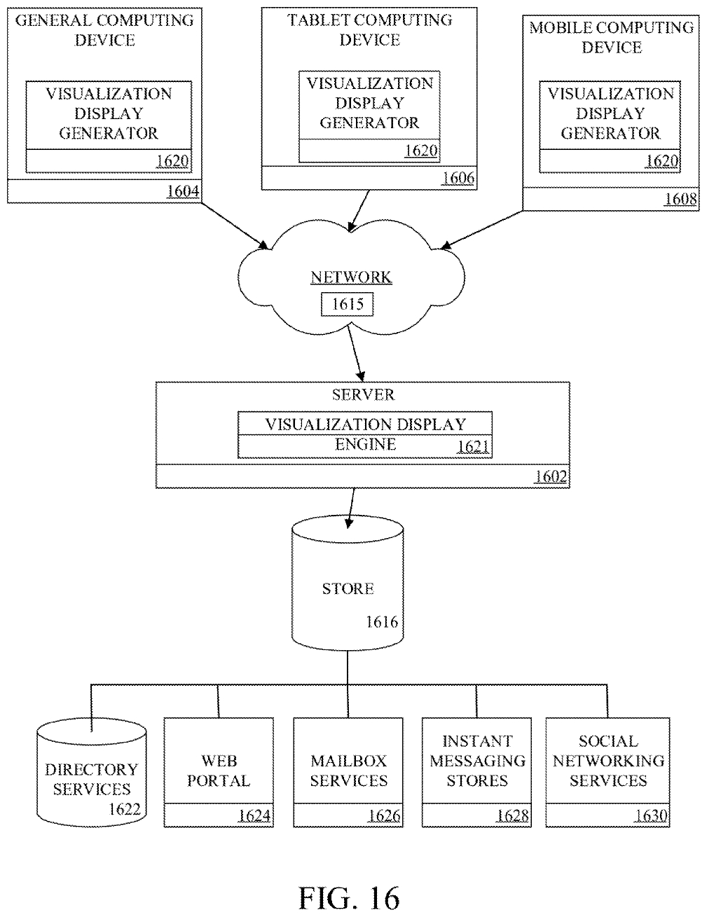

FIG. 16 illustrates one aspect of the architecture of a system for processing data received at a computing system from a remote source, such as a personal computer 1604, tablet computing device 1606, or mobile computing device 1608, as described above. Content displayed at server device 1602 may be stored in different communication channels or other storage types. For example, various documents may be stored using a directory service 1622, a web portal 1624, a mailbox service 1626, an instant messaging store 1628, or a social networking site 1630.

A model interaction manager 1620 may be employed by a client that communicates with server device 1602, and/or multimodal machine learning engine 1621 may be employed by server device 1602. The server device 1602 may provide data to and from a client computing device such as a personal computer 1604, a tablet computing device 1606 and/or a mobile computing device 1608 (e.g., a smart phone) through a network 1615. By way of example, the computer system described above may be embodied in a personal computer 1604, a tablet computing device 1606 and/or a mobile computing device 1608 (e.g., a smart phone). Any of these embodiments of the computing devices may obtain content from the store 1616, in addition to receiving graphical data useable to be either pre-processed at a graphic-originating system, or post-processed at a receiving computing system.

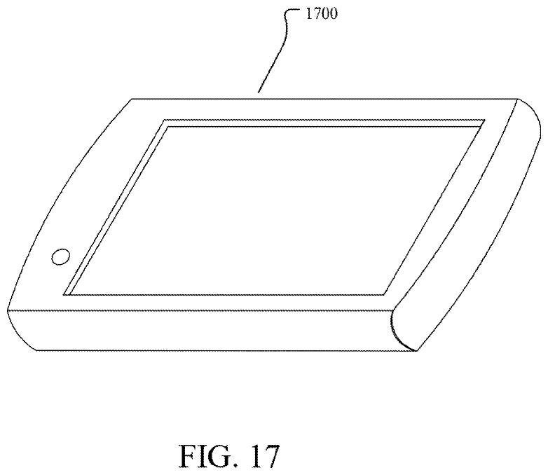

FIG. 17 illustrates an exemplary tablet computing device 1700 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving content from a knowledge base;
categorizing related content into a topic;
determining attributes of the topic;
generating a knowledge graph of related topics;
ranking the knowledge graph for importance by a relationship type;
filtering the knowledge graph based on a filtering parameter;
ranking the knowledge graph for relevance based on a relevance feature; and
generating, based on the ranked and filtered knowledge graph, a visualization display, wherein the visualization display comprises one or more of:
a root topic node;
a related topic node;
a connecting line between the root topic node and the related topic node; and
an interactive element accessible through the root topic node, related topic node and/or connecting line.

2. The system of claim 1, wherein content comprises one or more of: a document, email, online chat, meeting mentioning a topic or user, presentation, an address or location where a meeting or event will take place, a video recording of a meeting that happened online, the information of all users who participated in a meeting, phone number, email address, user contact information, organization contact information, team contact information, metadata, individual user, teams of users, top contacts for a user or who a user communicates with regularly.

3. The system of claim 1, wherein a knowledge base comprises an accumulation of content across a distributed network.

4. The system of claim 1, wherein an attribute comprises one or more of: a name of the topic, alternate names for the topic, a description of the topic, topic definitions, related people, related documents, related sites, related groups, related webpages or specific attributes for each type of topic.

5. The system of claim 1, wherein a relationship type comprises one or more of a topic to topic relationship, topic to document relationship, topic to user relationship, user to user relationship, user to document relationship and document to document relationship.

6. The system of claim 1, wherein a filtering parameter comprises one or more of filtering out related topic candidates if they do not co-occur in any document from a topic within n-levels of the root topic, filtering out documents if they have not been accessed within a certain time period, filtering out users if there has been no communication within a certain time period and/or filtering out users based on location.

7. The system of claim 1, wherein a relevance feature comprises one or more of a Jaccard overlap ratio between associated people and document sets for topic pairs, number of descriptions available for topic pairs, cosine similarity between topic embeddings produced on semantic content associated with topics, semantic embedding similarity on topic names, overlap ratio among established people for topics, semantic embedding similarity on topic names, count of established people for related topics, count of established documents for related topics, an overlap ratio among established documents for topics, count of definitions for related topics, semantic embedding similarity on top document titles, a count of definitions of source topic and/or the pre-trained knowledge graph directly to produce topic embeddings and cosine similarity.

8. The system of claim 1, wherein the visualization display is a graph visualization web component of n-levels.

9. The system of claim 1, wherein a related topic node comprises one or more of a discovered node, confirmed node and/or rejected node.

10. The system of claim 1, wherein an interactive element comprises one or more of a text box containing information and/or links to other topic pages associated with the connecting line, root topic node, related topic node, a topic legend and/or a search function.

11. A method comprising:
receiving content from a knowledge base;
categorizing related content into a topic;
determining attributes of the topic;
generating a knowledge graph of related topics;
ranking the knowledge graph for importance by a relationship type;
filtering the knowledge graph based on filtering parameters;
ranking the knowledge graph for relevance based on a relevance feature; and
generating, based on the ranked and filtered knowledge graph, a visualization display,
wherein the visualization display comprises one or more of:
a root topic node;
a related topic node;
a connecting line between the root topic node and the related topic node; and
an interactive element accessible through the root topic node, related topic node and/or connecting line.

12. The method of claim 11, wherein content comprises one or more of: a document, email, online chat, meeting mentioning a topic or user, presentation, an address or location where a meeting or event will take place, a video recording of a meeting that happened online, the information of all users who participated in a meeting, phone number, email address, user contact information, organization contact information, team contact information, metadata, individual user, teams of users, top contacts for a user, or who a user communicates with regularly.

13. The method of claim 11, wherein a knowledge base comprises an accumulation of content across a distributed network.

14. The method of claim 11, wherein an attribute comprises one or more of: a name of the topic, alternate names for the topic, a description of the topic, topic definitions, related people, related documents, related sites, related groups, related webpages, or specific attributes for each type of topic.

15. The method of claim 11, wherein a relationship type comprises one or more of a topic to topic relationship, topic to document relationship, topic to user relationship, user to user relationship, user to document relationship and document to document relationship.

16. The method of claim 11, wherein a filtering parameter comprises one or more of filtering out related topic candidates if they do not co-occur in any document from a topic within n-levels of the root topic, filtering out documents if they have not been accessed within a certain time period, filtering out users if there has been no communication within a certain time period and/or filtering out users based on location.

17. The method of claim 11, wherein a relevance feature comprises one or more of a Jaccard overlap ratio between associated people and document sets for topic pairs, number of descriptions available for topic pairs, cosine similarity between topic embeddings produced on semantic content associated with topics, semantic embedding similarity on topic names, overlap ratio among established people for topics, semantic embedding similarity on topic names, count of established people for related topics, count of established documents for related topics, an overlap ratio among established documents for topics, count of definitions for related topics, semantic embedding similarity on top document titles, a count of definitions of source topic and/or the pre-trained knowledge graph directly to produce topic embeddings and cosine similarity.

18. The method of claim 11, wherein the visualization display is a graph visualization web component of n-levels.

19. The method of claim 11, wherein a related topic node comprises one or more of a discovered node, confirmed node and/or rejected node.

20. The method of claim 11, wherein an interactive element comprises one or more of a text box containing information and/or links to other topic pages associated with the connecting line, root topic node, related topic node, a topic legend and/or a search function.
